(19) United States
(12) Patent Application Publication
(10) Pub. No.: US 2016/0201357 A1
(43) Pub. Date: Jul. 14, 2016

(54) TAMPER RESISTANT BICYCLE LOCK

(71) Applicant: David L. GEORGE, San Jose, CA (US)

(72) Inventor: David L. George, San Jose, CA (US)

(21) Appl. No.: 14/914,456

(22) PCT Filed: Aug. 26, 2014
(86) PCT No.: PCT/US2014/052682

§ 371 Date: Feb. 25, 2016

Related U.S. Application Data
(60) Provisional application No. 61/870,127, filed on Aug. 26, 2013.

(51) Int. Cl. E05B 27/00; E05B 71/00; E05B 67/22

(52) U.S. Cl. CPC E05B 27/0071; E05B 67/22; E05B 71/00

(57) ABSTRACT

A tamper resistant bicycle lock (10) is provided having a base (12) and a shackle (14) each provided with an interior ceramic layers to defeat attacks by thieves' tools. The shackle (14) is formed of a structural metal tube (32) having a case-hardened exterior (34) and a hollow interior (46) containing ceramic links (36). The arc segment (22) of the shackle includes fish-spline links (40) and is bent into shape subsequent to the installation of the ceramic links (40). The base (12) is formed of an elongated hollow bar (70) with ceramic rod segments (96) in corner bores (94). A lock cylinder subsystem (112) is situated in central bore (84) and is provided with a cylinder guard subsystem (114) including metallic (138) and ceramic disks (140). Additional metallic and ceramic layered components are also provided.

This is a non-provisional application. Priority is claimed from U.S. 61/870,127 filed 26 Aug. 2013, and U.S. 62/018,195 filed 27 Jun. 2014, and PCT/US2014/052682, all by the same current inventor.

### TECHNICAL FIELD

The present invention relates generally to security devices and structures and particularly to a bicycle lock which is tamper-resistant and provides high security.

### BACKGROUND ART

Theft of bicycles, motorcycles and other movable items is a bane of civilization. The ingenuity of malefactors is legendary in that methods of defeating security often improve and are developed at least as rapidly as the development of improved locks devised to prevent theft. Therefore, it requires continuing improvement in the locks developed to protect cycles, particularly as those cycles are more sophisticated and costly.

Of course, it is almost axiomatic that nothing is foolproof, or in this case “theft-proof”, so it often becomes a matter of trade-offs in cost, inconvenience for legitimate users, difficulty of defeat and the amount of time it takes to defeat any lock of similar theft-prevention structure. In this light, anything that makes it more difficult or tedious for the attacker to overcome the security structure can result in great benefits in the protection of property.

Over the years, many improvements have been made in construction materials have improved the efficacy of security structures. Improved alloys and the like have made it more difficult for thieves and the like to overcome them, but improved materials and sophistication in thieves' tools, such as rotary diamond cutters, laser cutters, and the like have kept pace. Consequently, a new method of approaching the problem is always desirable.

Accordingly, there is significant room for improvement and a need for better security structures, particularly bicycle locks which provide a very high degree of resistance to cutting, breaking, lock-picking or otherwise disabling attacks.

### DISCLOSURE OF INVENTION

Accordingly, it is an object of the present invention to provide a bicycle lock with bent and ceramic layered shackle and a ceramic layered base in order to thwart thieves and vandals.

Another object of the invention is to utilize a protocol for creating bent ceramic layering shackles to foil thieves who attack the shackle as a method of releasing a locked cycle.

A further object of the present invention is to provide a ceramic protected base and lock cylinder which is adapted to hinder, slow and otherwise frustrate the improved tools and methods being used by malefactors.

Yet another object of the invention is to provide base and shackle components with insulation provided by ceramic layers which frustrate heat cutting methods.

A further object of the present invention is to provide a shackle, a base structure, and a lock cylinder guard system, each of which provides, in layers, components for structural integrity and hardness, abrasive cutting resistance, heat cutting resistance, hammer drilling, heat and electromagnetic dissipation, and miscellaneous components.

Briefly, one preferred embodiment of the present invention is a bicycle lock having a shackle member bent into a usable shape (U-shape) with at least an exterior layer of a cut and crush resistant material and with at least one interior layer of heat and grind resistant ceramic, with the ceramic layer in the arc section of the shackle being in the form of nested links (fish) which are adapted to provide limited flexibility during bending of the shackle and thus avoid breaking during that step. Deluxe enhancements to the shackle include center components longitudinally arrayed within the ceramic layer to provide additional cutting resistance, thermal insulation, tool fouling lubricants and thief marker enhancements. A base member adapted to mate with the shackle has a metallic hollow outer bar with at least intermittent (corner) ceramic layering to foil diamond saws and other cutting attacks. A key lock system including a cylinder guard subsystem in layers adopted to resist several forms of attack prevents unauthorized (without the proper key) access to the lock cylinder from the key entry end of the base. Deluxe enhancements to the base include a hardened steel sheath circumferentially about the lock cylinder region, a ceramic sleeve inside the central bore, and multiple layered plug elements, separated by spacer tubes, as part of the cylinder guard subsystem.

An advantage of the present invention is that it provides for both a shackle and base for a bicycle lock which are highly resistant to breakage, mechanical and laser cutting, hammer drilling, melting, and other failure conditions.

Yet another advantage of the present invention is that utilizing nested discreet longitudinal segments of internal materials, especially ceramic links in the shackle and ceramic rod segments in the base, results in lower potential for catastrophic crushing or breaking and significantly easier assembly as opposed to continuous tubes.

A further advantage of the present invention is that it takes advantage of significant developments in the creation and cost-effectiveness of ceramic materials which may be incorporated into lock structures.

These and other objects and advantages of the present invention will become clear to those skilled in the art in view of the description of the best presently known mode of carrying out the invention and the industrial applicability of the preferred embodiment as described herein and as illustrated in the several figures of the drawings.

### BRIEF DESCRIPTION OF THE DRAWINGS

The purposes and advantages of the present invention will be apparent from the following detailed description in conjunction with the appended drawings in which:

FIG. 1 is a side elevational view of a bicycle lock according to the present invention;

FIG. 2 is a partially cut-away view of the arc portion of the shackle;

FIG. 3 is a cross-sectional view of the shackle of FIG. 2 taken along lines 3-3;

FIG. 4 is a cut-away side elevational view of a ceramic fish as utilized in the shackle;

FIG. 5 is a longitudinal cross-sectional view of the end portions of a simple base, showing the key, key tube, cylinder protection plug, lock mechanism, and the inserted free end of the shackle;

FIG. 6 is an end view of the base of the basic lock, showing the key insertion structure; and

FIG. 7 is a longitudinal detailed cross sectional view, similar to that of FIG. 5, of the layers of the deluxe preferred cylinder protection system.

### BEST MODE FOR CARRYING OUT THE INVENTION

The present invention is a bicycle lock 10 particularly adapted to prevent theft and tampering. The preferred embodiment of the bike lock 10 is illustrated in the several figures of the drawing and designated therein by the reference character 10. The bicycle lock is constructed in accordance with the method and protocol set forth in the inventor's contemporaneous Layered Mechanical Structures for Security Purposes application (incorporated by reference herein).

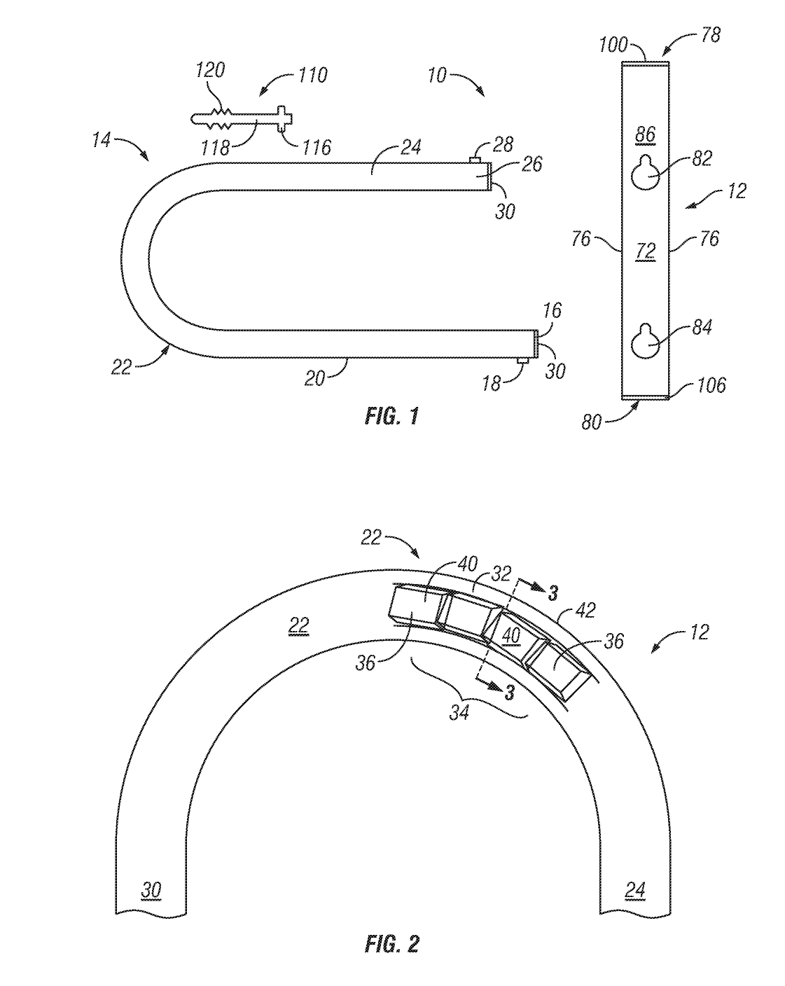

As shown in FIG. 1 the preferred bike lock 10 has a base member 12 and a shackle 14. The base member 12 has been rotated 90° about its longitudinal axis so the top surface is shown, rather than a side, in order to show how the two components will fit together in the locked (closed) mode. In this illustration the shackle 14 is shown in the open (unlocked mode). When the shackle 14 is engaged with and secured with the base (locked mode), as discussed hereinafter, a bicycle (or other item) can be secured to a post or other immovable object by having both the cycle and the object encompassed by the shackle 14.

The shackle 14 is illustrated in the overall view of FIG. 1 and the more detailed views of FIGS. 2-4. The general structure of the shackle 14 is an elongated U-shape and is shown to have a pivot end 16 having a pivot detent 18, a first straight segment 20 extending to a central arc segment 22, and a second straight segment 24 extending to a free end 26. The free end 26 includes a lock detent 28. A bottom cap 30 closes each ends 16 and 26. The first straight segment 20 in the preferred embodiment 10 is longer than the second straight segment 24 such that the pivot end 16 will extend beyond the base 12 when engaged in the lock mode while the free end 26 will be captured within the base 12.

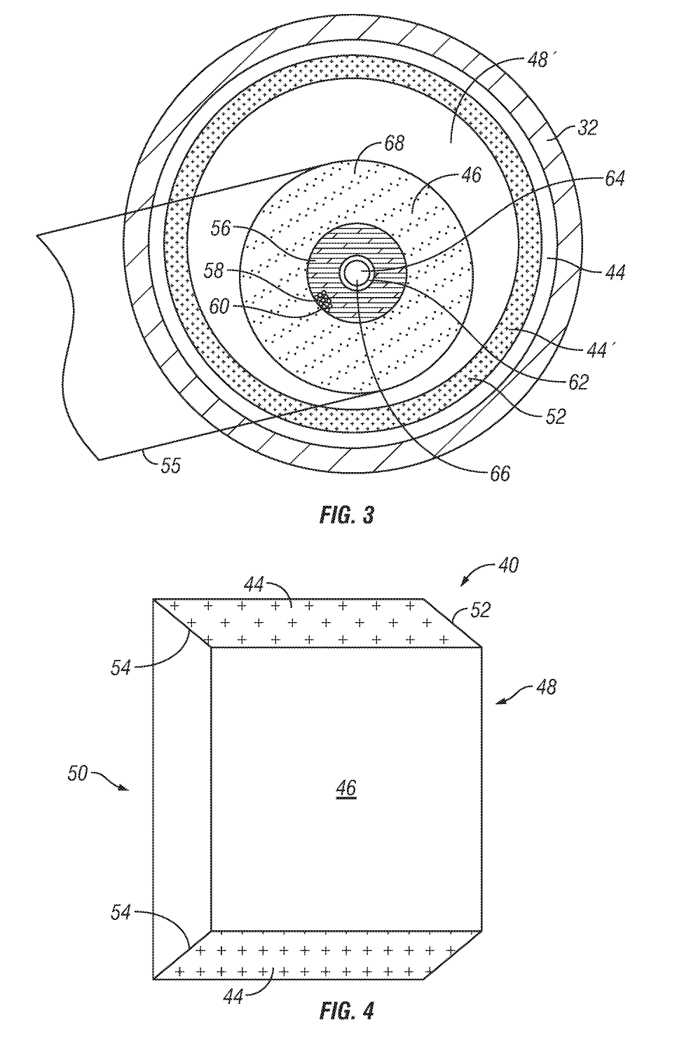

Referring now to FIGS. 2 and 3 the details of the shackle 14 are shown in a cut-away illustration of the arc segment 22 in FIG. 2 and in a cross-sectional view of FIG. 3. The shackle 14 is constructed with particular care to prevent destruction of its integrity by bolt cutters, diamond saws, manual saws, hammer drills, cutting torches, and other thieves' tools which are ordinarily used to destroy or defeat conventional bicycle lock structures. The shackle 14 is designed to have various layers adapted to thwart all of these forms of attacks.

In construction and formation, the shackle 14 begins as a straight length of hollow metal tube 32. A continuous array 34 of hollow ceramic links 36, some of which are elongated straight tube links 38 adapted to reside within the first and second straight segments 20 and 24 of the shackle 14, while the remainder are specially formed fish spline links 40 or “fish” 40 (see FIG. 4) which are adapted to reside in the arc segment 22, are then inserted into the metal tube 32, arrayed end to end so as to partially nest within each other. The shackle member is then subjected to a hot bend process where the metal is heated sufficiently to be malleable and is gently bent into the arc segment 22 in order to form a continuous element without seams or welds. The unique features of the fish 40, as described hereinafter, facilitate bending with and within the metal tube 32 to the extent necessary to form the arc segment 22 without cracking or crushing the ceramic fish 40.

Once in the proper shape in deluxe embodiments the shackle 14 is then subjected to case-hardening treatment, preferably by electromagnetic induction, to provide a case-hardened exterior 42, which is particularly resistant to bolt cutters, crushing, and drilling.

The details of the preferred ceramic fish-spline link/fish 40 selected for the preferred embodiment 10 are best understood form the longitudinal cross-sectional view of FIG. 4. The fish 40 is seen to be formed as a cylindrical ceramic tube 44 with a hollow interior 46. At the ends of the tube it is tapered to include a convex end 48 and a concave end 50. A convex taper 52 extends exteriorly from the ceramic tube 44 at the convex end 48, while a concave taper 54 extends into the interior of the ceramic tube 46 at the concave end 50. Both the convex taper 52 and the concave taper 54 extend at a taper angle 70 with respect to the ceramic tube 44. In the preferred embodiment 10, the taper angle 70 at each end is about 30°. In this manner, adjacent fish 40 may mesh with convex end 48 of one fish 40 meshing with the concave end 50 of an adjacent fish 40′ (as shown in FIGS. 2 and 3). Thus the rigid fish 40 may be formed into the curved array 34 within the arc segment 22 as shown in FIG. 2. This mesh fit facilitates bending the array 34, as is required in the hot-bend process described above.

The cross-sectional view of FIG. 3 illustrates the juxtaposition of adjacent fish 40 in the array 34. From the outside in, the layers are the metal tube 32, with a case-hardened exterior 42, a portion of the ceramic tube 44 and the concave taper 54 of one fish 40, and a portion of the convex taper 52 and the hollow interior 46 of a second fish 54′.

In deluxe embodiments of the invention, the hollow interior 46 of the array 34 may receive (ordinarily prior to insertion) further elongated elements in the form of center components 55 which help to insert the array 22 into the metal tube 32 and also to maintain abutment continuity.

In the deluxe (maximal security) preferred embodiment 10 the principal center component 55 is a flexible cable 56 (see FIG. 3) which is typically a mesh of flexible wires 58 (preferably music wire) and impact resistant fibers 60 (such as Kevlar®) which by distortion further resist cutting through the shackle 14, as the flexible cable 56 flattens rather than being cut. In extreme deluxe embodiments a capillary tube 62 filled with a thermal conductor 64 (such as Freon) may be inserted within or adjacent to the flexible cable 56 to carry extreme heat away from the locus of a cutting torch or the like, to provide thermal insulation during the heating and bending steps, and to further protect the center components 55 from breakage by thermal shock, as by freezing. An alternate or additional capillary tube 62 may include a marker 66, such as skunk scent to mark the perpetrator, thus aiding in enforcement in the event of theft or attempted theft. In addition, the preferred embodiment may include a foam lubricant 68 injected into the hollow interior 46 which will foil cutting wheels and also provide additional thermal insulation. The ceramic utilized in the fish 40 (preferably alumina with corundum) also provides thermal insulation and additional thermal protection for the core components 55. The combination of layers results, post heating and bending, in a structure of melted and fused core elements to defeat carbide and diamond tools (which are fouled by lubrication and adhesion to the blades) to provide a highly tamper proof bent shackle 14.

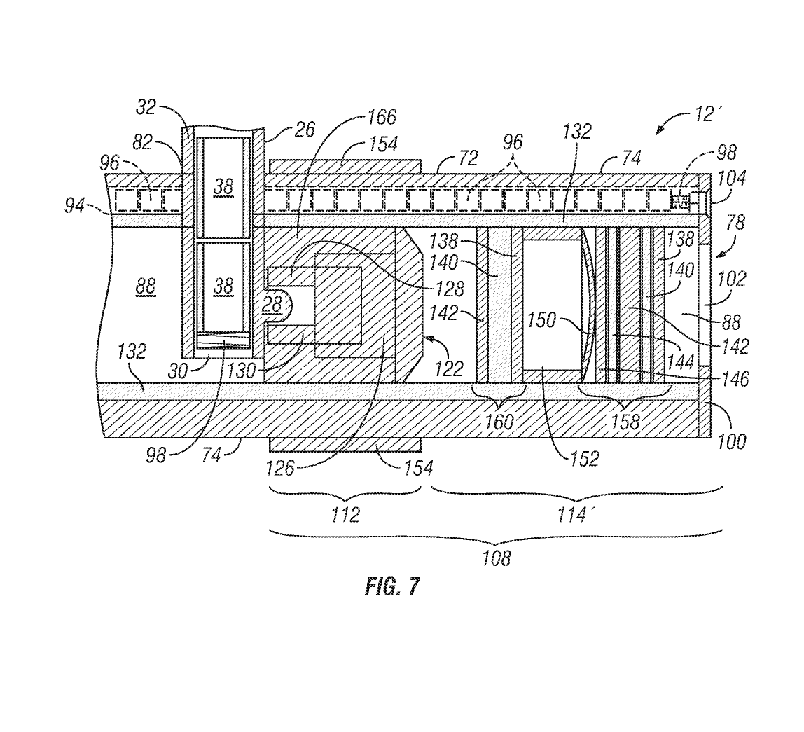

Turning now to the base 12, illustrated in FIGS. 1 and 5-7, additional anti-theft security features of the bicycle lock 10 are shown. The principal structural element of the base 12 is an elongated hollow bar 70, which in the preferred embodiment 10 is a structural metal having a square cross-section (see FIGS. 6 and 7), having a top side 72, a bottom side 74 and a pair of opposing lateral sides 76. The top view of the base 12 in FIG. 1 shows that the bar 70 has a first base end 78 (also referred to as the lock end 78) and an opposing second base end 80. A free end aperture 82 extends through the top side 72 at a position significantly offset from the first end 78 to receive the free end 26 of the shackle 14. Offset from, but relatively near the second base end 80 is a pivot aperture 84 which extends through both the top side 72 and the bottom side 74 to receive the pivot end 16 of the shackle 14. Both the free end aperture 82 and the pivot aperture 84 include a detent slot 86 extending toward the lock end 78 to respectively allow passage of the free end detent 28 and the pivot end detent 18 of the shackle 14, when properly oriented. In deluxe embodiments the base bar 70 is provided with a case-hardened surface 86 on all sides.

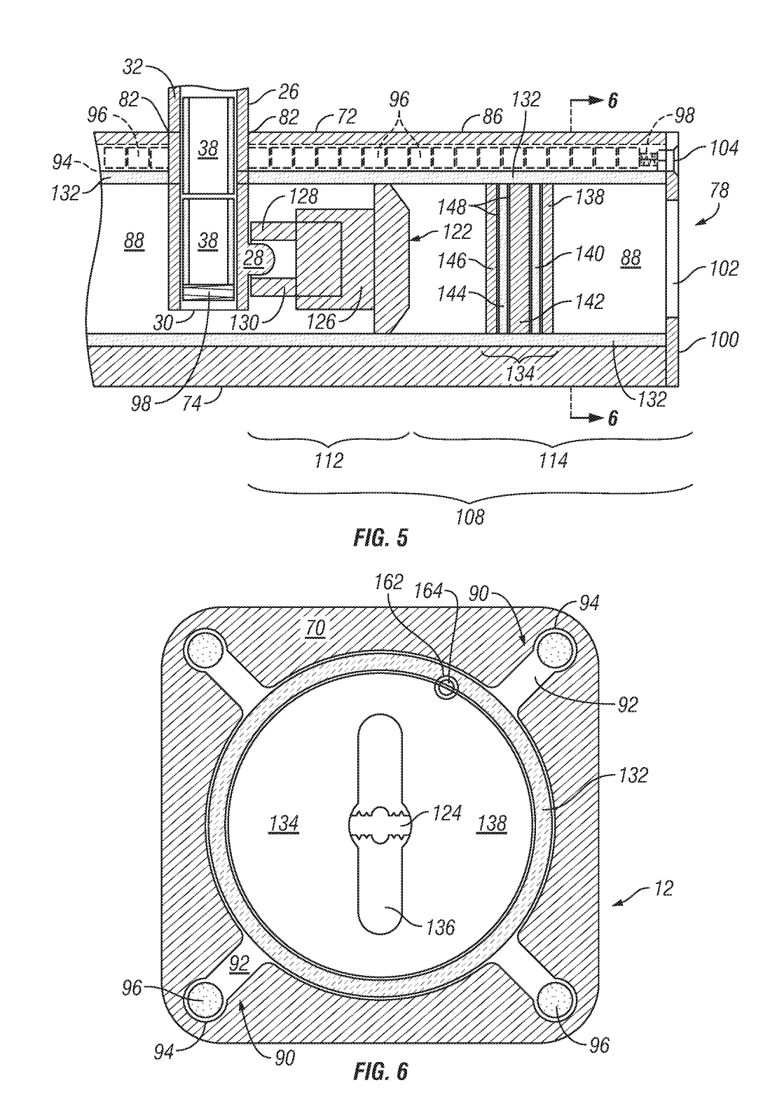

Referring now to FIGS. 5 and 6, a more basic embodiment of the preferred embodiment 10 is illustrated in a cross sectional longitudinal view (line 5-5 in FIG. 1) and a latitudinal cross sectional view just interior of the lock end 78 (line 6-6 of FIG. 1). In each figure it may be seen that the base 12 includes a central bore 88 which extends end to end of the hollow bar 70. The central bore 88 has a circular cross section with four nodes 90 extending toward the corners of the square. The nodes 90 (also known as “ears” 90) are formed in the extrusion process and have a narrow neck 92 adjacent to the central bore 88, and a corner bore 94. In the basic embodiment 10 the corner bores 94 are longitudinally filled by a series of ceramic rod segments 96. Compression springs 98 are then inserted at the ends of each corner bore 94 and a first end cap 100, provide with a key aperture 102 is secured to the lock end 78 by four fasteners 104 (one for each corner bore 94). The second base end 80 is similarly secured by a second end cap 106 which is a solid plate, using similar fasteners 104. The fasteners 104 are preferably rivets or drive screws (also known as “U-screws) to seal the ends in a manner which is very difficult for thieves to remove. The end caps 100 and 106 and associated fasteners 104 provide sufficient compression to the compression springs 98 that if any portion of a ceramic rod is drilled through, the compression spring 98 will cause the remaining rod segments 96 to push together to bind the drill bit and maintain an intermittent surrounding ceramic layer of protection for the central bore 88 and the mechanisms contained therein.

The preferred embodiments include a key lock system 108, the components of which, apart from a key 110 (shown in FIG. 1), are contained within the central bore 88, between the first end cap 100 and the free end aperture 82. The internal components of the key lock system 108 include a conventional lock cylinder subsystem 112 and an inventive cylinder guard subsystem 114. The key 110 itself is shown to have a handle 116, an elongated shaft 118 and an engagement section 120 which is shaped to semi-uniquely mate with the particular lock cylinder subsystem 112.

As shown in FIG. 5, where the bicycle lock 10 is illustrated in the locked mode, the lock cylinder subsystem 112 includes a cylinder 122, having a keyhole 124 (adapted to receive the particular key 110 utilized) a key engager 126, and a cam 128. The cam 128 is a half cylindrical member having a detent notch 130 adapted to capture the free end detent 28 of the shackle 14. When the key is turned in the key engager 126, the cam 128 is rotated such that that the free end detent 28 is released so the free end 26 may be lifted out of the base 12 and the captured items can be released.

The basic cylinder guard subsystem 114 is illustrated in FIGS. 5 and 6. In FIG. 6 the cylinder guard subsystem 114 is restrained within an optional ceramic sleeve 132 bonded to the surface of the central bore 88 as additional drilling and cutting protection. The cylinder guard subsystem 114 is primarily in the form of a layered plug 134 (see FIG. 5) which has a key passage 136 extending longitudinally therethrough (see FIG. 6). In the simple embodiment, the key passage 136 is aligned with the key aperture 102 in the first end cap 100 such that the key 110 may pass therethrough. However, as seen in FIG. 6, the keyhole 118 of the cylinder 116 is offset from the alignment of the key passage 136 such that the key must be turned after the engaging section has passed beyond the layered plug 134 in order to enter the keyhole 118. This arrangement foils lock picking attempts.

The simple preferred layered plug 134 illustrated in FIG. 5 is a series of wafers or disks (in a circular environment), each including a key passage 136, bonded together to provide a theft and damage resistant component. In particular the layered plug 134 is adapted to provide a multi-resistant barrier to prevent successful attacks on the lock cylinder subsystem 112 which could result in disengaging the shackle 14 and allowing the malefactor to make off with the bicycle or other locked object.

The particular layered plug 134 shown has five bonded layers including, from the first end inward, a stainless steel cover disk 138, a first ceramic wafer 140, a soft metal disk 142, a second ceramic wafer 144, and a tool steel base disk 146, all bonded together with adhesive 148 with the key passages 136 of each disk being co-aligned. The first and second ceramic disks in the preferred embodiment are typically formed either of ninety-five percent alumina (machinable) or ninety-nine percent zirconia corundum (not machinable but can be cast to be highly shock resistant, as well as being relatively immune to high and low temperature attacks).

Situated against the interior surface of the layered plug 134, abutting against the tool steel base disk 146, is a reaction spring 150. In the preferred embodiments 10 the reaction spring 150 is selected to be either a Smalley wave form spring or a Belleville washer.

The layered plug 134 acts to defeat tampering (and theft) by providing several layers of defense for the cylinder 122. Any attempt to drill out the cylinder 122 must first defeat the first end cap 100 and then each of the layers of the layered plug 134. The first end cap 100 provides initial resistance but can, with difficulty, be removed, broken, or drilled. The stainless steel cover disk 138 provides a difficult to break and drill first layer, as well as protection from the elements and chemical attacks. The first ceramic disk 140 is extremely resistant to both drilling and cutting and, if utilizing the zirconia corundum material, provides extreme resistance to thermal shocks (hot or cold). The central layer is the soft metal disk 142 which acts to clog diamond and carbide cutters. Next the second ceramic disk 144 provides the same sort of protection as the first and, like the first ceramic disk 140, also serves as a buffer between the metallic layers. Finally, the tool steel base disk 144 provides very high breaking strength to provide excellent structural integrity to the layered plug 134.

As thieves become more sophisticated they employ better tools. One that has recently become common is a hammer drill which uses high vibrational energy as a way of disrupting materials High frequency impacts (physical or sonic, as in a jackhammer) can act to shatter materials such as ceramics and cement if not actively resisted. In the present invention both of the preferred reaction spring 150 options react immediately and at the same frequency as the hammer drill. In this manner, the reaction spring 150 provides a counter thrust directly against the hammer drill and prevents the establishment of a vibrational oscillation, which can be especially destructive to ceramics.

Intermediate the reaction spring 150 and the cylinder 122, a lock spacer tube 152 is provided to ensure that enough room exists to rotate the key 110 once the key blade 120 (engagement section 120) has passed through the layered plug 134 and before it engages the keyhole 124.

FIG. 7, similar to FIG. 5 shows a deluxe embodiment 12′ of the base member (lock end). This illustration shows a ceramic sleeve 132 provided I the interior of the central bore 88 (see FIG. 6 which extends about the base 12′ from the first base end 78 to at least the free end aperture 82). The ceramic sleeve 132 proves additional cutting, sawing and drilling protection to the most vulnerable elements of the lock 10′. Similarly, a case hardened steel sheath 154 is provided to circumferentially surround the 12′ in the region of the lock cylinder subsystem 112 to provide additional protection against bolt cutters and the like.

While most of the internal components are the same as in the basic embodiment 12, the deluxe base 12′ includes an alternate cylinder guard subsystem 156 which includes both a first plug 158 and a second plug 160. The first plug 158 can be identical to the layered plug 134 of FIG. 5, complete with a reaction spring 150, while the second plug 160 may be less robust than the first plug 158, it should generally be sufficient to defeat most attacks. The second plug 160 illustrated in FIG. 7 has only three layers, with a soft metal disk 142 and a tool steel base 146 surrounding a first ceramic wafer 144. Spacer tubes 152 separate the first and second plugs 158 and 160 and also separate the second plug 160 from the cylinder 122.

The primary value in having the alternate cylinder guard subsystem 156 is to require additional rotational manipulation of the key 110, and by extension any lock picking tools or “skeleton” keys employed by thieves. The key passages 136 of the first plug 158 and the second plug may be rotationally offset form each other (ordinarily by ninety degrees). In all embodiments, the layered plug 134, the first plug 158 and the second plug 160 must be rotationally secured, ordinarily by notches 162 formed in each disk and the encasing element (either the central bore 88 or the ceramic sleeve 132) with associated notch pins 164 to maintain the rotational positioning Some adhesives may be sufficient for retaining rotational positioning but the mechanical alternative is considered to be superior by the inventor. A stainless steel cylinder jacket 166 may also extend immediately about the cylinder subsystem 112.

Also, if the first plug is sufficiently offset from the first end cap 100, a rotational offset may be also provided between the key aperture 102 and the key passage 136 of the first plug 158. In such a configuration the user will: insert the key 110 through the key aperture 102; rotate 90° to align with the key passage 136 in the first plug 158; push through such that the key blade 120 lies within the first spacer tube 152; rotate an additional 90°; and again push through the second plug 160 into the second spacer tube 152′; and rotate an additional 90° in order to engage the actual keyhole 124 of the lock cylinder 122. While this may result in extra work for the user in releasing the lock 10′ and the bicycle being secured thereby, it is even more frustrating to would be criminals attempting to defeat the lock structure.

When the bicycle lock is used, it is assumed to begin in the disassembled mode, as shown in FIG. 1. The pivot end 16 is positioned such that the pivot detent 18 is aligned with the pivot aperture 16 and is then pushed all of the way through the base 12. When this is completed, the shackle 14 is turned so the pivot detent 18 is no longer aligned with the pivot aperture 84 such that the shackle 14 is captured by the base 12. The shackle 14 is adapted to be released (to a limited extent) from the base 12 and to rotate about it in order to have enough freedom to be inserted through and around a portion of the protected item (usually a bicycle) and a fixed item, such as a post or rack. The base 12 is then rotated back to align the free end aperture 82 with the free end 26 of the shackle 14. The free end 26 is then inserted back into the base 12 such that the lock detent 28 engages the cam which mechanically rotates from the downward force until the lock detent 28 is captured within the detent notch 130, turning the keyhole as the cam 130 as rotated. Once the cam notch 130 and lock detent 28 engagement is complete the shackle 14 is secured within the base 14 and can only be released by using the key 110 as described above to turn the cam 128 back upward to release the shackle 14.

Different arrangements and key types may also be used in keeping with the cylinder guard subsystems discussed above. For example, the first plug 158 of the alternate cylinder guard 156 might be free to rotate within the central bore 88 and the key may be used to turn that item in such a way that the elongated shaft 118 can slide into a slot (aligned with the key aperture 102) formed in the key passage 136, while the key passage 136′ of the second plug 160 can only be accessed from that location in order to access the keyhole. Numerous other alignment and offset techniques will be obvious to locksmiths and lock manufacturers.

The preferred materials for various components are primarily discussed above. Many other materials with similar properties may be substituted with varying results but without necessarily straying from the invention.

Although the preferred embodiment is specified as a bicycle lock 10 it is understood that the principles of the invention, particularly those relating to the layered shackle and the cylinder guard system, are suitable for adaptation to other types of locks.

Dimensions and shapes of the security structures are entirely dependent on the particular application and can vary widely. In particular, tubular structures can be in any form of hollow shape, including cross-sections in the form of ovals, non-square rectangles and other geometric configurations.

Many modifications to the above embodiments may be made without altering the nature of the invention. The dimensions and shapes of the components and the construction materials may be modified for particular circumstances.

While various embodiments have been described above, it should be understood that they have been presented by way of example only, and not as limitations.

### INDUSTRIAL APPLICABILITY

The mechanical security locks, particularly in bicycle lock form, of the present invention are intended for use in any sort of circumstances where burglary, theft and other forms of tampering and trespass are feared.

The use of multi-layered shackles with metallic and ceramic layers and especially including center components 55 such as flexible interior cables, foam lubricants and capillary tubes infused with thief markers, results in requiring malefactors to invoke multi-pronged methods of attack in order to breach or defeat the security structure. In many cases, this will defeat the typical attempt and will, at the very least, require a great deal more time and effort on the part of the perpetrators. This may have the beneficial effect of causing the selection of easier targets. All of these factors result in greater protections of bicycles and other properties than are possible with security structures according to prior art methods and protocols.

Greater effectiveness in security is the cause of significant economic advantage. In addition, construction techniques utilizing intermittent layering or modular discreet longitudinal ceramic components can lessen material costs and/or simplify assembly.

For the above, and other, reasons, it is expected that the improved bicycle locks and other types of locks according to the present invention will have widespread industrial applicability. Therefore, it is expected that the commercial utility of the present invention will be extensive and long lasting.

While various embodiments have been described in the specification, it should be understood that they have been presented by way of example only, and not limitation. Thus, the breadth and scope of a preferred embodiment should not be limited by any of the described exemplary embodiments, but should be defined only in accordance with the following claims and their equivalents.

What is claimed is:

1. A bicycle lock, comprising:
a base having shackle receiving apertures and containing a lock cylinder and locking components within a central bore,
a shackle having a pivot end and a free end for mating with said shackle apertures, said free end being adapted to be engaged with said locking components; wherein
ceramic layers to defeat thieves tools are provided within said base surrounding said lock cylinder said locking components, and within the interior said shackle, said ceramic layer within said shackle being in the form of discreet hollow ceramic links.

2. The bicycle lock of claim 1 wherein
said shackle is in the form of a structural metal tube and includes an arc segment bordered by first and second straight segments; and
said discreet hollow ceramic links are arrayed longitudinally inside said metal tube.

3. The bicycle lock of claim 2 wherein
said ceramic links have a hollow interior for receiving center components for the further purpose of frustrating thieves' tools.

4. The bicycle lock of claim 3 wherein
said ceramic links contained within said arc section are fish-spline links.

5. The bicycle lock of claim 4 wherein
said ceramic links contained within said straight segments are elongated tube links.

6. The bicycle lock of claim wherein
said center components within said hollow interior including at least an elongated flexible cut-resistant cable.

7. The bicycle lock of claim 6 wherein
said center components further include a capillary tube containing a marker.

8. The bicycle lock of claim 1 wherein
said base is a hollow bar which further includes longitudinal bores strategically place to intermittently surround said central bore, said longitudinal bores containing ceramic rod segments.

9. The bicycle lock of claim 1 wherein
said lock cylinder is protected by a cylinder guard subassembly situated exterior to said lock cylinder within said center bore.

10. The bicycle lock of claim 9 wherein
said cylinder guard subassembly includes at least two metal wafers and at least one interspersed ceramic wafer and a spring element.

11. The bicycle lock of claim 1 wherein
said shackle is in the form of a structural metal tube with a case-hardened exterior surface and includes an arc segment;
said discreet hollow ceramic links with hollow interiors are arrayed longitudinally inside said metal tube, said discreet ceramic hollow links contained within said arc section being fish-spline links;
center components extend within said hollow interior of said array, said center components including at least an elongated flexible cable and a capillary tube including a marker; and
said lock cylinder is protected by a cylinder guard subassembly situated exterior to said lock cylinder within said center bore

12. A shackle for a lock, comprising
a metal tube having a case hardened exterior surface and including a first straight segment, an arc segment and a second straight segment; and
an array of ceramic links longitudinally disposed within said metal tube, said ceramic links having a hollow interior.

13. The shackle for a lock of claim 12, wherein
said ceramic links contained within said arc section being fish-spline links.

14. The shackle for a lock of claim 12, and further including
center components disposed in said hollow interior of said array, said center components including at least an elongated flexible cable.

15. The shackle for a lock of claim 14, wherein
said center components further include a lubricant.

16. The shackle for a lock of claim 12, wherein
said array of ceramic links is provided with terminal compression springs to maintain internal pressure

17. A base for a shackle-type lock, comprising:
an elongated hollow bar formed of structural metal and having a longitudinal central bore;
a lock cylinder subsystem situated within said central bore, including shackle capturing components; and
ceramic layering components disposed through and within said hollow bar for protecting said lock cylinder subsystem from attacks by thieves' tools.

18. The base for a shackle-type lock of claim 17 wherein
said ceramic layering includes ceramic rod segments arrayed within longitudinal bores in said elongated hollow bar, said longitudinal bores being displaced circumferentially about said central bore.

19. The base for a shackle-type lock of claim 17 and further including
a cylinder guard subsystem disposed within said central bore exterior to said lock cylinder subsystem, said cylinder guard subsystem including at least two metal wafers and at least one interspersed ceramic wafer.

20. The base for a shackle-type lock of claim 17 and further including
a steel sheath surrounding said lock cylinder.
